(19) United States
(12) Patent Application Publication
(10) Pub. No.: US 2004/0151501 A1
(43) Pub. Date: Aug. 5, 2004

(54) Method and system for supervising an optical network termination unit

(76) Inventors: Johannes Gerdes, Waldsolms (DE); Matthias Foerster, Kelkheim (DE); Harald Zottmann, Kleinostheim (DE)

Correspondence Address: TROP PRUNER & HU, PC, 8554 KATY FREEWAY, SUITE 100, HOUSTON, TX, 77024, US

(21) Appl. No.: 10/359,031

(22) Filed: Feb. 5, 2003

(51) Int. Cl. H04J 14/00

(52) U.S. Cl. 398/72

(57) ABSTRACT

A method for supervising an optical network termination unit (18) from a remote headend (14) that is connected to the termination unit through a fiber-optical link (20), the termination unit having an optical input side (32) receiving a transmitted signal (Tx) from the headend, and an optical output side (34) transmitting a signal to be received by the headend as a received signal (Rx), the method comprising the steps of:

optically coupling said input side to said output side, thereby to form a passive optical loop,

passing a loop control signal (LCS) from the headend through said loop, and

detecting the loop control signal at the headend.

### BACKGROUND OF THE INVENTION

1. Field of the Invention

The invention relates to optical data transmission networks and, more particularly, to a method and system for supervising an optical network termination unit.

An optical network comprises at least two separate units that are capable of exchanging data through optical fibers. A unit of this type that serves as an interface between the network and a client is termed optical network termination unit. This termination unit is connected to another unit of the network, a so-called headend unit, through a fiber-optical link comprising one or more optical fibers. In a typical setup, the headend forms part of a larger network and serves as the unit through which the client has access to this network. The distance covered by the fiber-optical link between the headend and the termination unit is typically relatively small and may range from several meters to about 10 km, for example.

The termination unit forms part of the customer premises equipment and is connected to further equipment that is owned by the client. However, the termination unit itself forms part of the network that is managed by a network operator. Thus, when a failure occurs in the data transmission between the network and the client, it is desirable for the network operator to be able to decide whether the failure has occurred in the network equipment, including the termination unit, or in the client's own equipment. This is why the optical network termination unit should be “manageable” in the sense that it is possible to supervise the function of this termination unit and of the fiber-optical link from the remote headend.

2. Description of the Related Art

In a conventional optical network, the network termination unit includes active electro-optical elements so that it is capable of actively responding to standardized control signals that are transmitted from the headend through a standardized Optical Supervisory Channel (OSC). The active optical elements in the termination unit increase the installation costs for the network as a whole and also require an increased floorspace in the customer premises equipment. Moreover, these active elements may by themselves be the source of system failures, e.g. in case of a breakdown of the power supply for the customer premises equipment. Moreover, the active elements provided in the termination unit for supervising purposes will have to be adapted to the specific bitrate or bitrates employed in the data traffic with the client.

### SUMMARY OF THE INVENTION

It is accordingly an object of the invention to provide a method and system that reduce the costs and floorspace required for the optical network termination unit and yet permits a stable and reliable supervision of the termination unit.

According to the invention, this object is achieved by a method for supervising an optical network termination unit from a remote headend that is connected to the termination unit through a fiber-optical link, the termination unit having an optical input side receiving a transmitted signal from the headend, and an optical output side transmitting a signal to be received by the headend as a received signal, the method comprising the steps of:

optically coupling said input side to said output side, thereby to form a passive optical loop,

passing a loop control signal from the headend through said loop, and

detecting the loop control signal at the headend.

It is thus an important feature of the invention that there is provided a fully manageable passive optical termination unit that, from the viewpoint of the client, is fully transparent and, accordingly, does not have to be adapted to the specific bitrates used by the client. The stability and reliability of the system is improved, because the passive termination unit does not rely upon an electric power supply nor on active electro-optical elements which may be subject to failure. Since the passive optical loop may simply be formed by simple, commercially available optical splitters, couplers, multiplexers or the like, the installation costs are reduced significantly, and the floorspace requirement on behalf of the client is reduced as well.

Although the loop control signal that is passed through the passive loop may be attenuated to a considerable degree, depending upon the length of the fiber-optical link, it has been found that it is still possible to obtain on the side of the headend a detectable optical signal that is sufficient for monitoring the network connection for failure and degradation.

The invention also provides a suitable hardware for carrying out the method described above.

In a simple embodiment, the loop control signal that is passed through the closed loop may be identical with the wanted signal that is transmitted from the headend to the client. Then, the termination unit will include an optical splitter on the input side of the termination unit, for splitting-off a portion of the transmitted signal, and, on the output side, an optical coupler for coupling the split-off portion into the receiving channel of the fiber-optical link, so that it may be received in the headend. The client will use the same channel of the fiber-optical link for sending a wanted data signal to the headend. This data signal, which is to be received by the headend, will be termed “received signal” hereinafter. In order to be able to distinguish the loop control signal from the received signal, it is preferable that the received signal is transmitted at an optical wavelength different from that of the transmitted signal and hence also from the wavelength of the loop control signal.

In a preferred embodiment, the loop control signal is separate from the transmitted signal and is multiplexed therewith in the transmission channel of the fiber-optical link, e.g. by wavelength or polarization multiplexing. Then, it will be possible to use the same wavelength for the transmitted signal and the received signal.

Preferably, in order to avoid adverse effects resulting from cross-coupling between the loop control signal and the transmitted and received signals, the loop control signal should be a modulated optical signal. Then, when the loop control signal is detected in the receiving channel on the side of the headend, it is possible to use the well-known technique of “Synchronous Optical Detection” (SOD) which provides a remarkably high detection sensitivity, so that the loop control signal may reliably be detected even in case of a relatively large signal attenuation in the passive closed loop.

In a particularly advantageous embodiment, course or dense “Wavelength Division Multiplexing (WDM) is used for simultaneously transmitting a plurality of wanted signals, and one of the multiplexed channels is used for the loop control signal.

### BRIEF DESCRIPTION OF THE DRAWINGS

Preferred embodiments of the invention will now be described in conjunction with the drawings, in which:

FIG. 1 shows an overall setup of an optical network to which the invention is applicable;

FIG. 2 is a more detailed diagram of a headend and a termination unit of the network, in accordance with one embodiment of the invention; and

FIGS. 3 and 4 are block diagrams similar to FIG. 2 illustrating other embodiments of the invention.

### DETAILED DESCRIPTION OF THE PREFERRED EMBODIMENTS

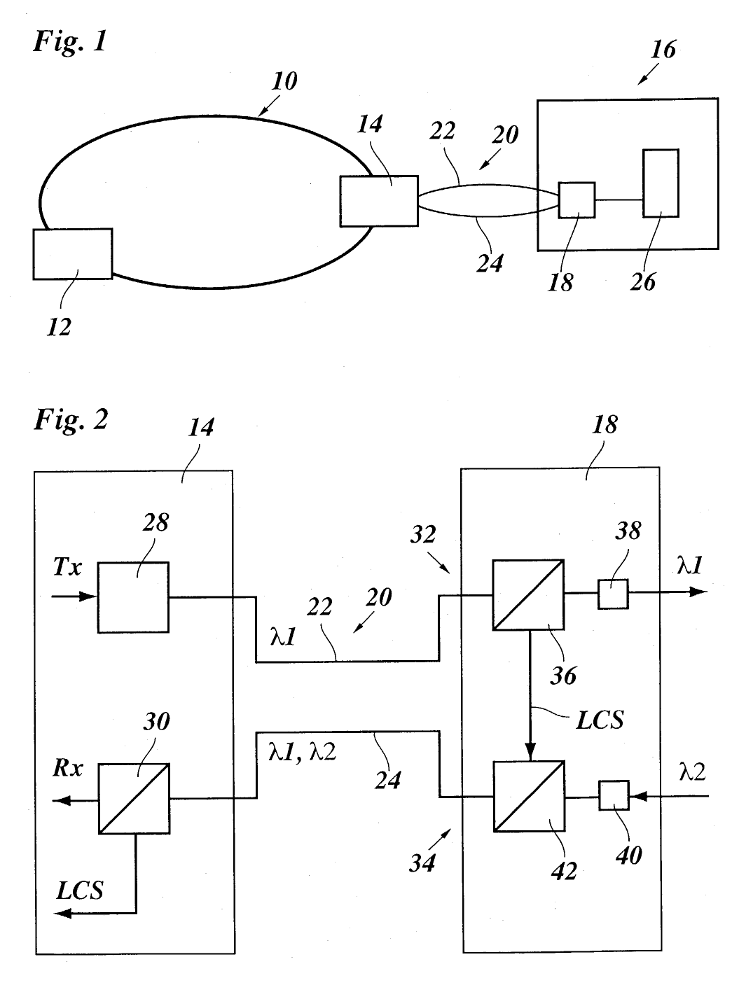

As is shown in FIG. 1, an optical network 10 comprises a plurality of nodes 12, 14 at least on of which is configured as a headend 14 through which a client 16 has access to the network. The customer premises equipment of the client 16 comprises an optical network termination unit 18 that is connected to the headend 14 through a fiber-optical link 20. The fiber-optical link 20 may comprise a single optical fiber or separate optical fibers for a transmission channel 22 and a receiving channel 24. By convention, “transmission” refers to the transmission of data from the headend 14 to the termination unit 18, and “receiving” refers to the reception of data from the termination unit 18 at the headend 14.

The optical network termination unit 18 serves as an interface between the network 10 and the client 16 and is optically connected to the client's own equipment 26.

As is shown in FIG. 2, the headend 14 comprises a transmitter 28 for sending a transmitted signal Tx to the termination unit 18 via the transmission channel 22 of the fiber-optical link 20. The transmitted signal Tx may have been received from the network 10 or may as well have been generated in the headend.

The headend 14 further comprises a receiver 30 which receives a signal that has been sent from the termination unit 18 over the receiving channel 24 of the fiber-optical link and is passed-on into the network 10 as a received signal Rx.

The optical network termination unit 18 comprises an optical input side 32 connected to the transmission channel 22 and an optical output side 34 connected to the receiving channel 24. The optical input side 32 includes an optical splitter 36 splitting the transmitted signal Tx into a wanted portion that is passed-on to the client's equipment 26 through a connector 38, and a control portion that shall be used as a loop control signal LCS. The optical output 34 side comprises a connector 40 through which the received signal Rx is received from the clients equipment, and an optical coupler 42 which couples the received signal Rx with the loop control signal LCS, so that both signals are multiplexed on the receiving channel 24.

It shall be assumed here that different optical wavelengths are used for the transmitted signal Tx and the received signal Rx. For example, a wavelength λ1 of 1550 nm is used for the transmitted signal Tx and a wavelength λ2 of 1310 nm for the received signal Rx.

The receiver 30 in the headend 14 is configured as a wavelength demultiplexer which separates the loop control signal LCS from the received signal Rx. Thus, the loop control signal LCS can be detected and continuously monitored on the side of the headend 14, even in time periods in which the receiving channel 24 is busy with transmitting a wanted data signal form the client into the network.

When the system is operating without any defects, the loop control signal LCS will be detected at the headend 14 with a known intensity. In case of degradation or breakdown of the fiber-optical link 20, the detected signal LCS will have a smaller intensity or will be absent completely. Thus, the function of the fiber optical link and the termination unit 18 can be supervised without any need for active optical elements in the termination unit 18. The supervision system is fully transparent to the client and does not depend on the specific bitrate that is used by the equipment 26 of the client. Thus, this equipment may be adapted to any known standard such as SDH, GbE, FICON, ESCON, and the like.

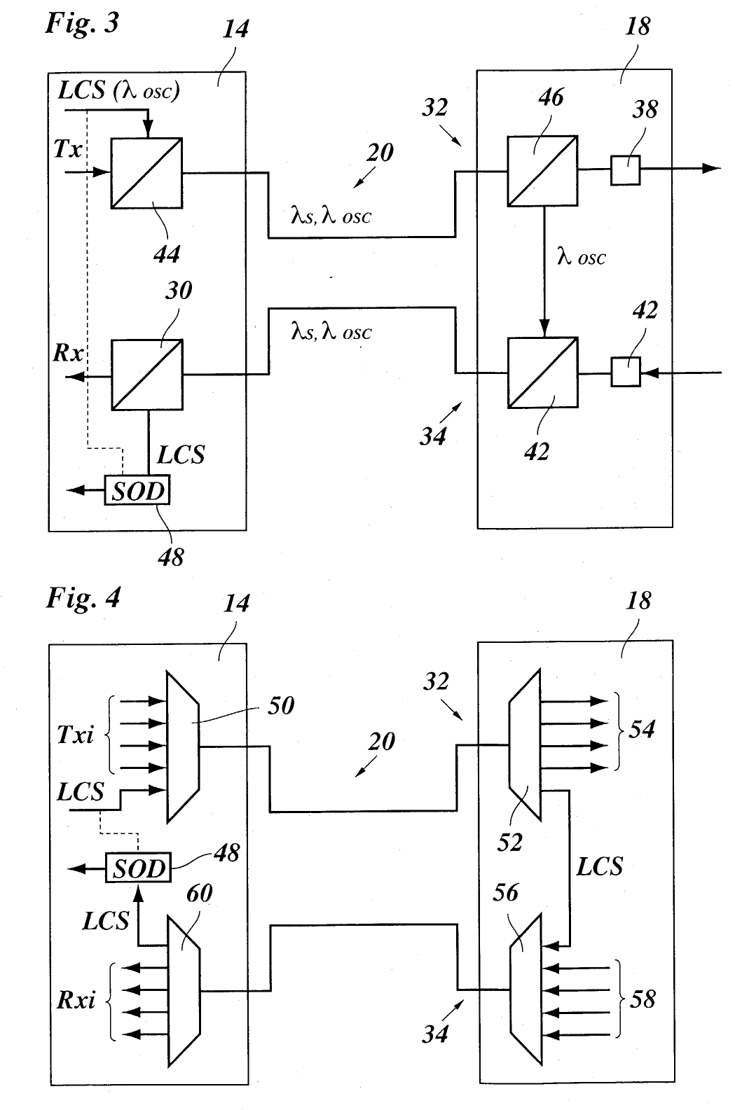

FIG. 3 shows a modified embodiment which permits also to use the same wavelength λs for the transmitted signal Tx and the received signal Rx. In this embodiment, the transmitter in the headend 14 is configured as a wavelength multiplexer 44 which multiplexes the transmitted signal Tx with the loop control signal LCS which in this case is a modulated signal with a wavelength λ_{OSC} of the Optical Supervisory Channel. The wavelengths λₛ and λ_{OSC} may be in the same or different optical windows of the fiber-optical link 20.

The input side 32 of the termination unit 18 comprises in this case a wavelength demultiplexer 46 separating the transmitted signal Tx from the loop control signal LCS. On the output side, the loop control signal is multiplexed with the received signal Rx by means of the coupler 42 or a multiplexer.

In the headend 14, the wavelength demultiplexer 30 separates the loop control signal LCS from the received signal Rx. The loop control signal is then detected with high sensitivity by a synchronous optical detection device 48 in synchronism with the modulation of the original loop control signal, as is symbolized by a dotted line in FIG. 3.

Again, the loop control signal is passed through a passive optical loop including the demultiplexer 46 and the coupler 42 as passive optical elements. The high sensitivity of the synchronous optical detection permits to compensate even a large attenuation of the loop control signal.

In a modified embodiment, the loop control signal, modulated or not, may be polarization-multiplexed with the transmitted signal Tx. In this case, the demultiplexer 46 may be a polarization sensitive splitter which permits a relatively high intensity of the signal that is looped back to the headend 14.

FIG. 4 shows yet another embodiment in which Wavelength Division Multiplexing (coarse or dense) is used for simultaneously transmitting a plurality of transmitted signals Txi and received signals Rxi through the fiber-optical link 20. In the headend 14, multiplexer 50 has a plurality of inputs for optical signals which have different wavelengths. One of these inputs is used for the loop control signal LCS. The termination unit 18 includes on the input side a demultiplexer 52 with a plurality of outputs 54 for forwarding the transmitted signals Txi to the client, one of the outputs being left for the loop control signal LCS. Conversely, the output side has a multiplexer 56 with a plurality of inputs 58 for the received signals Rxi, and another input reserved for the loop control signal LCS which is thus looped back to the headend 14. There, a demultiplexer 60 separates the loop control signal LCS from the received signals Rxi and feeds the same to the synchronous optical detection device 48. In this case, the termination unit 18 needs to include only the passive optical demultiplexer 52 and the passive optical multiplexer 56 that are needed anyway for the transmission of the multiplexed wanted signals, and the passive optical loop is formed simply by connecting one of the outputs of the demultiplexer 52 to one of the inputs of the multiplexer 56. Of course, if the intensity of the signal that has been looped back is large enough, so that SOD is not needed, the loop control signal LCS does not have to be modulated.

What is claimed is:

1. A method for supervising an optical network termination unit from a remote headend that is connected to the termination unit through a fiber-optical link, the termination unit having an optical input side receiving a transmitted signal from the headend, and an optical output side transmitting a signal to be received by the headend as a received signal, the method comprising the steps of:
optically coupling said input side to said output side, thereby to form a passive optical loop,
passing a loop control signal from the headend through said loop, and
detecting the loop control signal at the headend.

2. The method of claim 1, wherein the loop control signal is identical with the transmitted signal.

3. The method of claim 2, wherein the transmitted signal and the received signal have different optical wavelengths, and the step of detecting the loop control signal at the headend comprises a step of separating the loop control signal from the received signal by wavelength-demultiplexing.

4. The method of claim 1, wherein the loop control signal and the transmitted signal have different optical wavelengths, the step of passing the loop control signal through the loop comprises the steps of separating the loop control signal from the transmitted signal by wavelength-demultiplexing and wavelength-multiplexing the separated loop control signal with the received signal in the termination unit, and the step of detecting the loop control signal at the headend comprises a step of separating the loop control signal from the received signal by wavelength-demultiplexing.

5. The method of claim 4, wherein the loop control signal is modulated before it is passed through the loop, and the step of detecting the loop control signal comprises a step of synchronous optical detection of the loop control signal in synchronism with the modulation thereof.

6. The method of claim 1, wherein the loop control signal and the transmitted signal have different polarizations, the step of passing the loop control signal through the loop comprises the steps of separating the loop control signal from the transmitted signal by polarization-demultiplexing and polarization-multiplexing the separated loop control signal with the received signal in the termination unit, and the step of detecting the loop control signal at the headend comprises a step of separating the loop control signal from the received signal by polarization-demultiplexing.

7. The method of claim 6, wherein the loop control signal is modulated before it is passed through the loop, and the step of detecting the loop control signal comprises a step of synchronous optical detection of the loop control signal in synchronism with the modulation thereof.

8. An optical network termination unit arranged to be supervised from a remote headend that is connected to the termination unit through a fiber-optical link, the termination unit having an optical input side receiving a transmitted signal from the headend, and an optical output side transmitting a signal to be received by the headend as a received signal, wherein the termination unit comprises a passive optical coupling device for coupling the input side to the output side.

9. The termination unit of claim 8, wherein the passive optical coupling device comprises on optical splitter in the input side and an optical coupler provided in the output side and adapted to wavelength-multiplex the received signal with an optical signal obtained from said splitter.

10. The optical network termination unit of claim 8, wherein said passive optical coupling device comprises, on the input side, a wavelength demultiplexer with two outputs, and, on the output side, a wavelength multiplexer having an optical input coupled to one of the outputs of the wavelength demultiplexer.

11. The network termination unit of claim 8, wherein the optical coupler comprises, on the input side, a WDM-demultiplexer having a plurality of outputs, and, on the output side, a WDM-multiplexer having a plurality of inputs, one of the outputs of the WDM-demultiplexer being optically coupled to one of the inputs of the WDM-multiplexer.

12. A system for supervising the optical network termination unit of claim 9, comprising, in said headend, a wavelength demultiplexer adapted to demultiplex the optical signal received from the output side of the termination unit.

13. A system for supervising the optical network termination unit of claim 10, comprising, in said headend, a wavelength multiplexer adapted to multiplex the transmitted signal with a loop control signal, the multiplexed signal being transmitted to the input side of the termination unit, said headend further including a wavelength demultiplexer adapted to demultiplex an optical signal received from the output side of the termination unit.

14. The system of claim 13, wherein the wavelength multiplexer of the headend is arranged to receive a modulated loop control signal, and the wavelength demultiplexer of the headend is connected to a synchronous optical detection device for detecting the loop control signal.

15. A system for supervising the optical network termination unit of claim 11, comprising, in said headend, a WDM-multiplexer adapted to multiplex a plurality of transmitted signals with a loop control signal, the multiplexed signal being sent to the input side of the termination unit, the headend further comprising a WDM-demultiplexer connected to the output side of the termination unit through said fiber-optical link.

16. The system of claim 15, wherein the WDM-multiplexer of the headend is arranged to receive a modulated loop control signal, and the WDM-demultiplexer of the headend has one output connected to a synchronous optical detection device for detecting said loop control signal.
